(19) United States
(12) Patent Application Publication
(10) Pub. No.: US 2018/0247275 A1
(43) Pub. Date: Aug. 30, 2018

(54) OMNI-CHANNEL TRANSACTION VISUALIZATION

(71) Applicant: NCR Corporation, Duluth, GA (US)

(72) Inventors: Goran Petrov, Duluth, GA (US); Ashutosh Prasad, Duluth, GA (US); Andrew Wright, Duluth, GA (US)

(21) Appl. No.: 15/444,236

(22) Filed: Feb. 27, 2017

(51) Int. Cl. G06Q 10/10; G06Q 40/02

(52) U.S. Cl. CPC G06Q 10/1097; G06Q 20/1085; G06Q 40/02

(57) ABSTRACT

Examples of a system and method for transaction scheduling are generally described. A method may include providing a notification to a user including a suggested time and day for performing a transaction task based on a scheduled location for a previously scheduled task, and receiving current location information for the user at a current time. The method may include, in response to determining that the current location information indicates an improvement to one or more parameters associated with the suggested time and day, sending an indication to the user to perform the transaction task at the current time.

### BACKGROUND

Many customers are faced with the challenge of finding time to do important tasks. Often customers face a lack of planning that results in missed opportunities, or a waste of time and money. For example, some customers forget o pay bills, or forget to run an errand while out, Current techniques do not allow a customer to plan financial activities within their daily life plan. Current techniques also fail to give customers the ability to foresee and react to changes automatically and intelligently.

### SUMMARY

In various embodiments, methods and systems for transaction scheduling are presented,

According to an embodiment, a method may include providing a notification to a user including a suggested time and day for performing a transaction task based on a scheduled location for a previously scheduled task. According to an embodiment, a method may include sending an indication to a user to perform a transaction task at the current time in response to determining that current location information indicates an improvement to one or more parameters associated with a suggested time or day.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally a schematic diagram of communication devices for scheduling tasks in accordance with some embodiments.

FIG. 2 illustrates generally a map for conceptualizing and displaying transaction scheduling routing in accordance with some embodiments.

FIG. 3 illustrates generally a calendar for transaction scheduling and management in accordance with some embodiments.

FIG. 4 illustrates generally a system for transaction scheduling in accordance with some embodiments.

FIG. 5 illustrates generally a flowchart showing a technique for transaction scheduling in accordance with some embodiments.

FIG. 6 illustrates generally a flowchart showing a technique for providing options for fulfilling a transaction in accordance with some embodiments.

FIG. 7 illustrates generally a flowchart showing a technique for updating transaction fulfillment options based on a change in availability in accordance with some embodiments.

FIG. 8 illustrates generally a flowchart showing a technique for providing updated transaction fulfillment options based on a location change in accordance with some erribodiments.

FIG. 9 illustrates generally a flowchart showing a technique for calendar synchronization in accordance with some embodiments.

FIG. 10 illustrates generally an example of a block diagram of a machine upon which any one or more of the techniques discussed herein may perform in accordance with sonic embodiments.

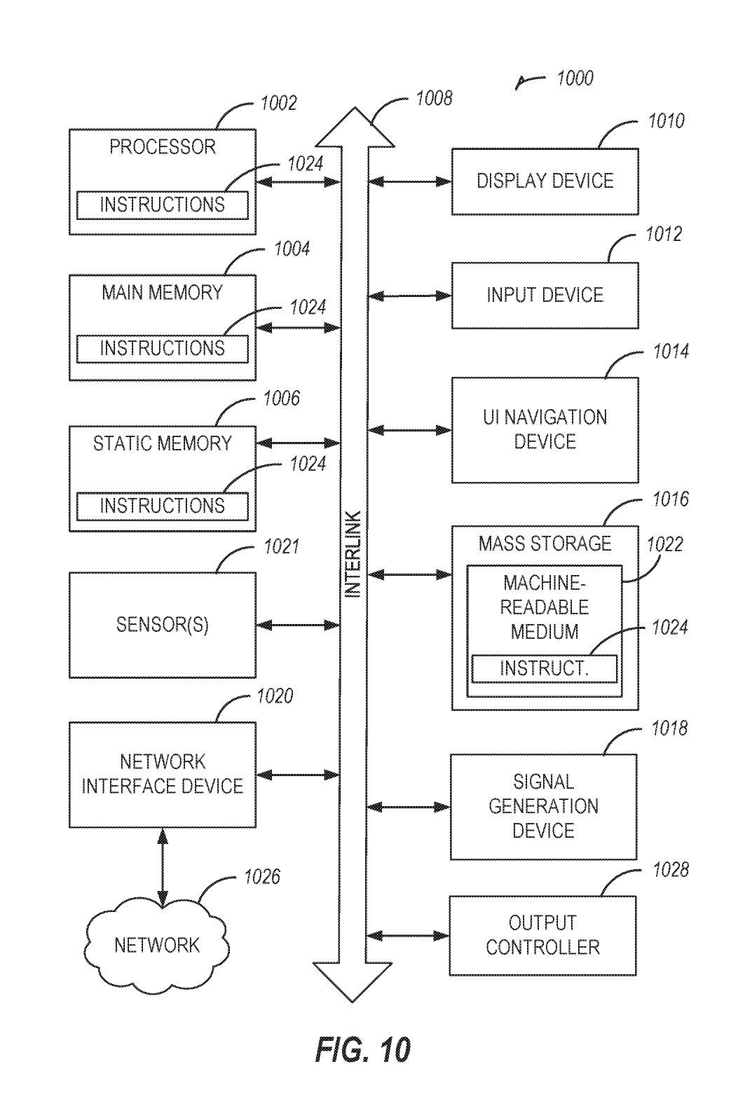

### DETAILED DESCRIPTION

The systems and methods described herein allow a customer to plan financial activities within their daily life plan, and allow customers the ability to foresee and react to changes intelligently. The systems and methods described herein are used to visualize and plan resources, devices, and channels to complete of an omni-channel transaction. An omni-channel transaction is one that is location or device independent, residing on a system that may be accessed interchangeably among different interfaces or devices. The interfaces or devices may include, but are not limited to, a website or an app on a computing device, a mobile device, or a tablet, an automated teller machine (ATM), a self-service terminal (SST), a kiosk, an interactive teller machine (ITM), a recycles, at a bank branch, a phone service, a point of sale (POS) device, or the like. A user may access any channel and see a stage of a current transaction, and may see activities or resources required to complete the transaction.

Systems and methods described herein may include automatically scheduling tasks, such as transaction tasks. For example, an entry may be added to a. calendar of a user based on availability of the user. Suggestions may be made for placement or modification of the entry. The suggestions may be optimized by using location information to find a scheduling slot for a task. For example, the task may be matched to previously scheduled errands, a current location of a user, a future location of the user, known locations frequented by the user, or the like, such as to avoid unnecessary trips. For example, the suggestions may include time or day suggestions, locations suggestions, routing suggestions, or the like.

In an example, a method may include providing two-way synchronization between a system and a user calendar. For example, the system may include omni-channel functionality and the user calendar may be updated from a plurality of devices in the omni-channel. The user calendar may be changed by a user, and the changes may be pushed to the system, such as via a device of the omni-channel. A status of a task on the user calendar may be updated automatically, such as to include “pending” or “completed” when the task is pending or has been completed respectively. In an example, tasks may be automatically rescheduled, such as when a time to complete a task has passed. The task may be rescheduled based on channel and consumer availability. Example tasks or transactions may include a deposit of cash or coins, a check deposit, a cash withdrawal, completing a portion of a mortgage or loan application, purchasing or redeeming a certificate of deposit (CD), accessing a safety-deposit box, or the like.

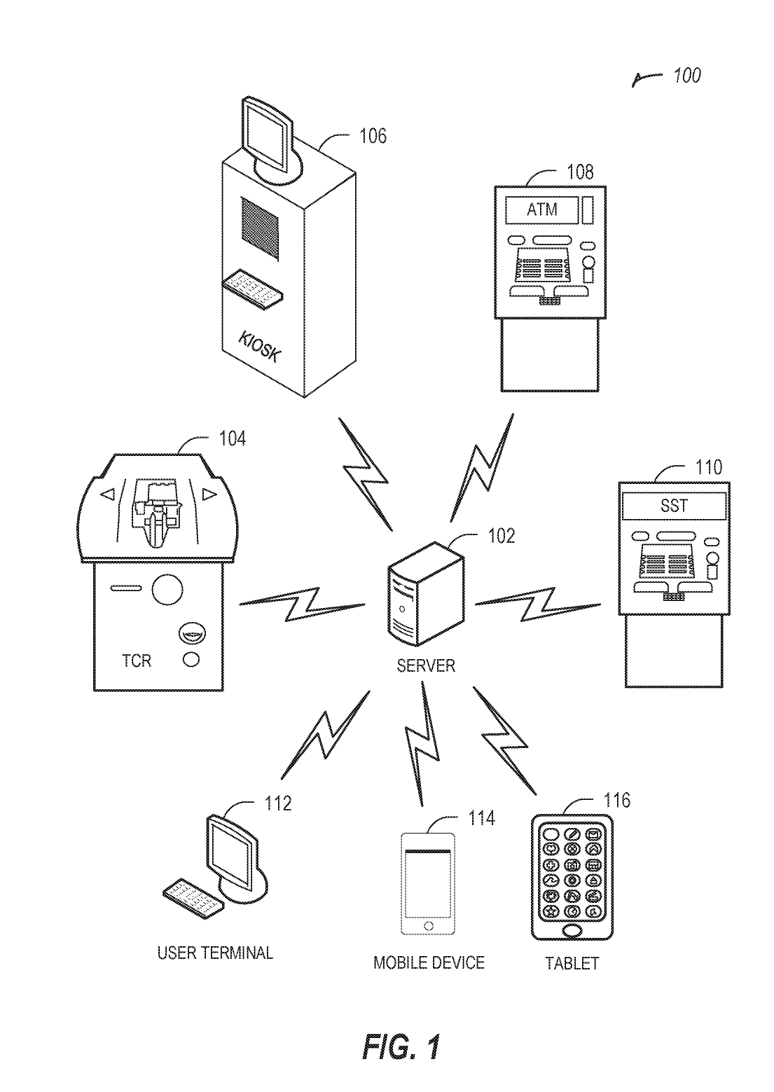

FIG. 1 illustrates generally a schematic diagram 100 of communication devices for scheduling tasks in accordance with some embodiments. The communication devices may include a recycler 104, a kiosk 106, an ATM 108, a SST 110, a user terminal 112 or computer, a mobile device 114, or a tablet 116. These communication devices may communicate with a server 102. The server 102 may store transaction information and provide the transaction information to the communication devices when a user accesses one of the communication devices.

Tasks may be planned automatically by the server 102 or other device of an omni-channel system, which may be in communication with one or more of the communication devices 104-116. The server 102 may be used to automatically schedule tasks for a user based on a user calendar, user preferences, user activities, a user location or future location, or the like. In an example, when a user is near or at a location with one or more of the communication devices 104-112, the user may receive a reminder, at the one or more of the communication devices 104-112, at the mobile device 114, or at the tablet 116. The reminder may include a notification of a task to complete at the one or more of the communication devices 104-112, an additional task to be completed after a present task is finished, or the like.

The tasks may be scheduled according to expected wait times e.g., related to a line at a bank branch or for the ATM 108), availability of services (e.g., a bank branch that offers mortgage applications), availability of cash (e.g., whether the ATM 108 has sufficient cash to withdrawal), functionality (e.g., whether the ATM 108 has a service scheduled or needs repair), distance from the user or from a future location of the user, fees associated with the transaction at a particular location or with a particular device, availability of others to complete the task (e.g., a family member), time available to the user, time required to complete the task at a particular location or with a particular device, deviation from a planned route, location or timing of events on a calendar, number of tasks to be completed, type of task, weather, traffic, user preferences, or the like.

The communication devices 104-116 may include a security option for the user to access an account over the omni-channel system. For example, the communication devices 104-116 may communicate with the server 102 to verify and authenticate the user. In an example, the user may use the mobile device 114 to authenticate, such as by using near filed communication (NFC), may scan a QR code, or may provide another way to authenticate, such as a traditional PIN (e.g., via the ATM 108, the SST 110, or the recycler 104). After authentication, the task may be completed or fulfilled. Pending transaction subtasks within a task may be executed one by one or in parallel. For example, a task may include depositing a check and withdrawing cash, which may be done in sequence or in parallel. A communication device (e.g., 104-116) used to fulfill one of the subtasks may show a status of other subtasks. In an example, subtasks or tasks may include pre-staged transactions which may automatically be completed at an appropriate communication device. For example, a cash withdrawal may be scheduled using the user terminal 112, the mobile device 114, or the tablet 116 at a first location (e.g., a user's home), and then the cash withdrawal may be completed when a user accesses the ATM 108, the recycler 104, the kiosk 106, or the SST 110. This completion may be done automatically' (e.g., automatically withdraw cash when making a purchase or accessing the ATM 108). The communication devices 104-116 may display a completion status (e.g., pending or completed), or may display a next subtask.

In an example, a user may initiate a plurality of different transactions, which may require one or more channels (e.g., locations or devices to complete). The user may be provided with a plan to complete these transactions. For example, multiple destinations, locations, or a route may be displayed along with optional times or dates for completion. The tasks may be collected as subtasks into a larger single scheduling task, which may include ordered subtasks (e.g., one to complete before another). The user may access the plan from any channel (e.g., on a browser, such as at the user terminal 112, on the mobile device 114, the tablet 116, the ATM 108, the recycler 104, the kiosk 106, the SST 110, etc.) and may see an up to date status of the plan, as well as the tasks and subtasks available (e.g., pending or completed). An active device of the communication devices 104-116 may be designated, such as when a user accesses the omni-channel system via the active device. The active device may display notifications, routes, plans, tasks, changes, or the like to the user. The active device may change when the user accesses another device. A default active device may be selected (e.g., when the user is not actively using any device, send passive notifications to the mobile device 114 of the user).

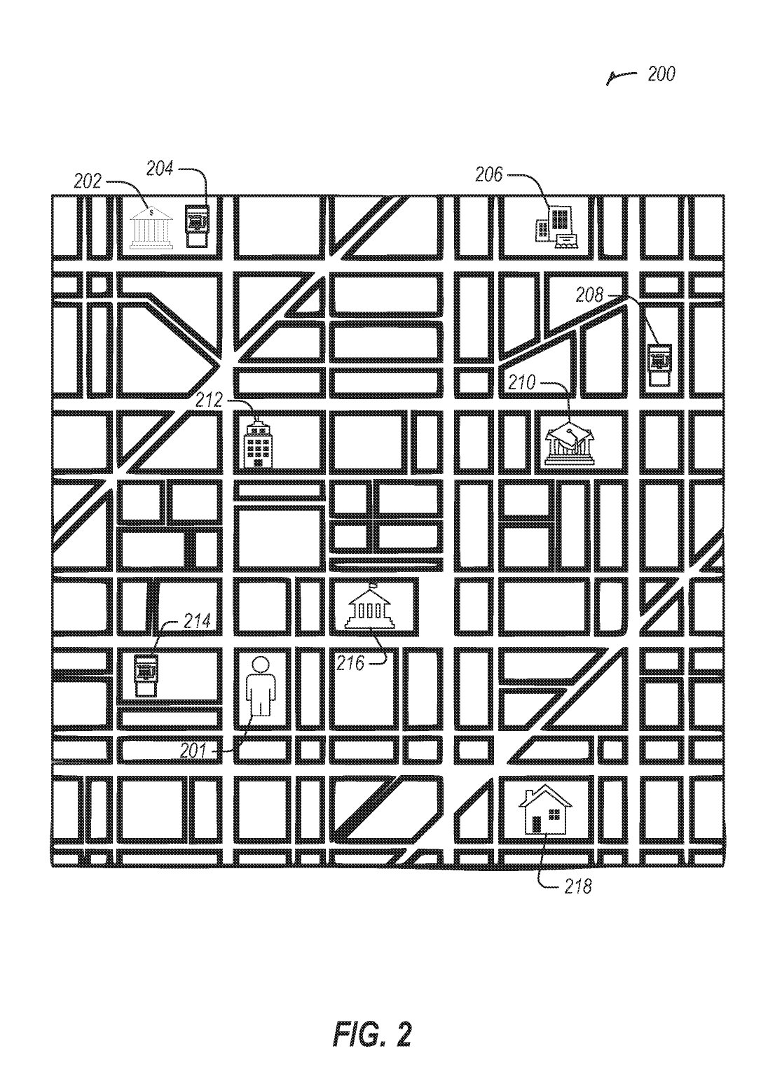

FIG. 2 illustrates generally a map 200 for conceptualizing and displaying transaction scheduling routing in accordance with some embodiments. A user 201 is illustrated on the map 200. The map illustrates various destinations, such as a bank branch 202, a first SST 204, an office building 206 (e.g., corresponding to a workplace of the user 201), a second SST 208, a school 210, a building 212, a third SST 214, a government building 216, and a house 218 (e.g., corresponding to a home of the user 201). A route may be provided on the map, such as a route from where the user 201 is located to a destination (e.g., one or more of locations 202-218) or a route from one destination to another. The route may be displayed with intermediate stops to perform tasks or with suggested deviations or additions to the route to complete tasks.

In an example, route suggestions may be provided based on a task to be completed by the user 201. For example, the task may include stopping at an ATM (e.g., 201, 208, or 214). If the user has an errand scheduled at the school 210, the user may be directed to the ATM 208 before or after the scheduled errand, since the ATM 208 is geographically close to the school 210. In another example, if the task requires services at a bank branch, the user 201 may be directed to the bank branch 202. The user 201 may receive suggested times to complete the task at the bank branch 202. such as when the user 201 has free time and the bank branch 202 is open, or when the user is traveling hear the bank branch 202. In an example, if the user 201 frequently goes to the building 212, such as to exercise at a gym in the building 212, the user 201 may be given a route to the bank branch 202 from the building 212 at or with a suggested time for completing the task, such as before or after the user 201 typically goes to the gym.

In an example, one or more of the ATMs 204, 208, or 214 may charge a fee for certain transactions. The user 201 may have a task for which the closest ATM 214 charges a fee. The user 201 may be given an option to complete the transaction at the closest ATM 214 for a fee and may be given an option to complete the task at the closest free ATM, for example ATM 204. The user 201 a preferred choice, or may preselect preferences (e.g., never pay ATM fees, always choose the closest regardless of fees, give me options, only show ATMs within 5 miles, time limits, etc.).

In an example, the user 201 may be given choices based on a current location or proximity to transaction fulfillment locations. In another example, the user 201 may be given choices based on future locations of the user 201 determined from events on a calendar. In yet another example, the user 201 may be given choices based on likely future locations of the user 201, determined from past activities (e.g., going to the gym, typical lunch restaurants, etc.) that may not appear on a calendar. The likely future locations may be, for example, a grocery store, where the user 201 is known to frequent weekly on Tuesday nights. The user 201 may be provided with a suggestion to delay completing a transaction until Tuesday night if there is an ATM in the grocery store. The user 201 may include in the transaction details a time that the transaction should be completed by. The user 201 may manually modify the suggested route, time, or location for completing the transaction after the suggestion is given to the user 201. In an example, the user 201 may reject the proposed route, location, or time, and a new route, time, or location may be provided. The location of the user 201 may be monitored, such as using a mobile device of the user to provide updated routes or suggested times or locations for completing a transaction. The monitoring may include typical work times, sleep times, etc., of the user 201 to know when the user 201 is available to complete a task. The user 201 may set preferences, for example, that the user 201 is open to travelling, but does not want to pay fees. The preferences may limit or expand, such as including times, fees, distance, area (e.g., neighborhood), brand (e.g., owner of ATM), type, desired order of subtasks, or sequence of events, or the like. In an example, the map may automatically check for a threshold distance to the locations (e.g., the ATMs or a SST or the bank branch 202) before recommending a route.

The user 201 may be monitored for changes in plan. hen the location of the user 201 changes, location-based notifications may be sent o the user 201. For example, if the user 201 ends up near the bank branch 202, a notification may be sent to the user 201 to deposit cash or move up or change a previously scheduled transaction. In another example, a reminder may be issued at an ATM about other tasks the user 201 has pending. The user 201 may be tracked at different devices or locations across different channels to provide a better experience for the user 201, so that the user 201 does not miss out on a most convenient opportunity to complete a task. Other real-time aspects of an mini-channel system may be tracked to provide a convenient experience to the user 201. For example, a transaction may be scheduled on a real-time basis for ATM stocking, how busy the bank branch 202 is (e.g., long line or some unexpected event), what traffic is present along a route, construction along a route, weather, etc.

In an example, the user 201 may have a transaction that requires multiple subtasks. For example, when applying for a loan or mortgage, the user 201 may need to fill out multiple forms or meet with certain people. If a person at the bank branch 202 who the user is scheduled to meet with calls in sick, a notification may be sent to the user 201 indicating such. The user 201 may select whether to reschedule to another person or to another time or to another day. Applying for a loan or mortgage may have multiple subtasks, such as an interview, money transfer, documents to be signed, etc. Some of these subtasks may be scheduled for completion at the bank branch 202 (e.g., the interview or money transfer), some subtasks may be scheduled at one of ATMs 201, 208, or 214 (e.g., money transfer or documents to be signed), and some subtasks may be completed at the house 218 or the office 206 of the user (e.g., signing documents or money transfer). Location-independent tasks may be shown separately from location-dependent tasks or time-independent tasks may be shown separately from time-dependent tasks.

The user 201 may initiate multiple transactions or complex tasks, such as a mortgage application, which consist of several steps to complete on any device. As the complex tasks are broken down into subtasks, they may be integrated into third party calendars or other platform for users to share, such as on a shared calendar. The shared calendar may be used to coordinate with peers or family members to dynamically assign subtasks of complex tasks to be executed by individuals and updated for the group. For example, applying for a mortgage may include multiple subtasks, which may be completed by any member of a family or company, and the completion of these subtasks may be update a shared calendar. Some subtasks may need to be completed by a specific individual, which may be incorporated into this system (e.g., signing a particular document).

Tracking of the user 201 across various platforms, devices, and locations may use one or more tracking technologies. The technologies may be used to present real-time options for completing a transaction. In an example, a technology to track the user 201 may include terminal services (e.g., server data), a RESTful application programming interface (API), a map API, a calendar API, mobile device location services, global positioning system (GPS), local positioning system (e.g., within a building, neighborhood, or city, such as by making use of Wi-Fi access points or cell towers for location information) or the like.

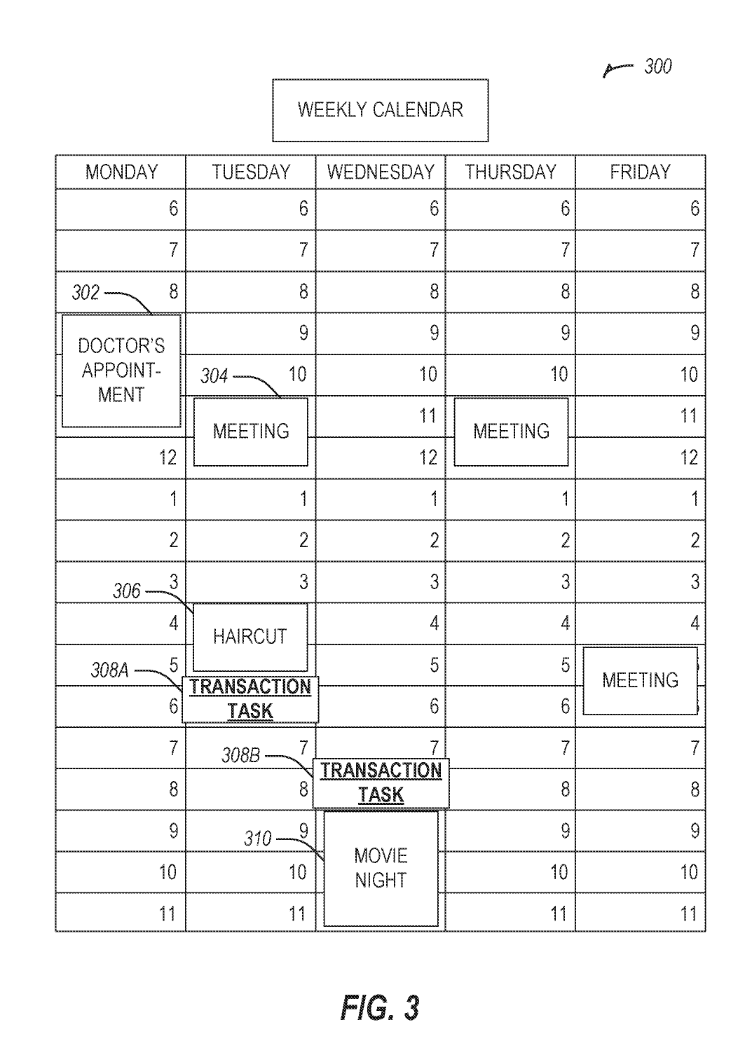

FIG. 3 illustrates generally a calendar 300 for transaction scheduling and management in accordance with some embodiments. The calendar 300 includes a plurality of scheduled appointments or tasks, such as a doctor's appointment 302, a meeting 304, a haircut 306, and a movie night 310. The calendar 300 includes an example transaction task calendar entry at two example locations 308A-308B.

A system for transaction scheduling may use the calendar 300 to schedule a transaction task. For example, a user may enter a transaction task to be completed. The system may determine locations of tasks previously scheduled on the calendar (e.g., 302, 34C), 306, and 310), a current location of the user, a potential future location of the user, etc., and determine a convenient time for the transaction task to be scheduled. The convenient time may be based on user preferences, such as desiring free rather than paid transactions, maximum driving distance, etc. Once determined, the system may provide a notification to the user or add an entry to the calendar 300 at a particular suggested time and day for the transaction task.

For example, the system may determine that during the haircut 306 calendar entry, the user will be near (e.g., within a three minute walk or five minute drive) of an ATM. The system may schedule the transaction task 308A immediately after the haircut on Tuesday. In an example, the ATM adjacent to the haircut location may charge a fee for the desired transaction task. The system may change to a second option to schedule the transaction task 308B before a movie night 310 calendar entry on Wednesday if an ATM at the movie theater is free for the user to complete the transaction task. In another example, the system may offer both options with an indication that one is a fee-charging option. The user may desire to complete the task before Wednesday, and thus may select the transaction task at 308A or may desire to not pay a fee, and thus may select the transaction task at 308B. In yet another example, the system may predetermine from previous user selections or user preferences that the user would select transaction task time 308A or 308B and automatically offer the predetermined selection (e.g., the user may only see the predetermined option). In an example, if the user drives by a third ATM on Wednesday morning, the system may notify the user that the ATM would be more convenient (e.g., earlier in time) and recommend completing the transaction task at the third ATM. If this option is selected and the user completes the transaction task at the third ATM, the transaction task 3088 may be removed from the calendar 300 or may be updated to indicate that the task is complete.

The calendar 300 presented in HG. 3 may be a user calendar or a group calendar, such as a family calendar or company calendar. Transaction tasks times such as 308A or 308B may be suggested for a particular group member to complete (e.g., the haircut 306 may be for a first user, and the movie night 310 for two other users, and if the first user is not able to complete the transaction task 308A, the task may fall to the two other users to complete before the movie night 310). A system using the calendar 300 may seek confirmation from a user that the transaction task has been completed or is still pending before deleting, marking complete, or moving the transaction task. In an example, when the user is at an ATM performing a function, the ATM may show advertising, such as a new bank loan or a credit card with an option to apply. Selecting the option or other aspect of the advertising may trigger setting a new scheduled task.

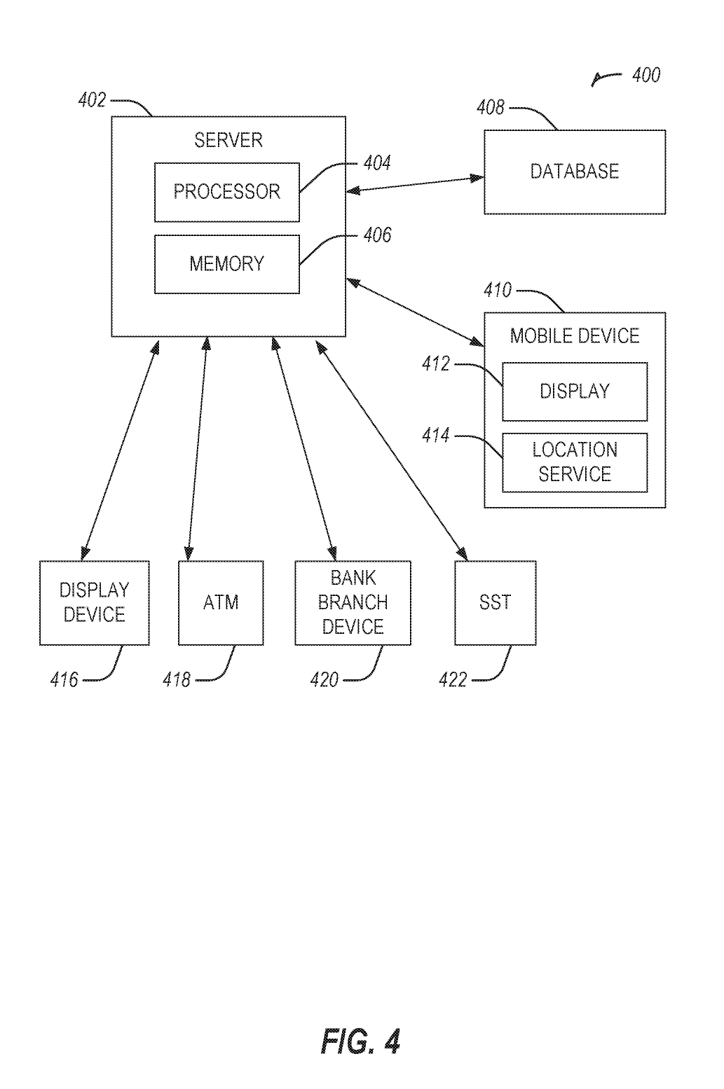

FIG. 4 illustrates generally a system 400 for transaction scheduling in accordance with some erribodiments. The system 400 includes a server 402 which may be in communication with a mobile device 410, a display device 416 (e.g., via a computer), an ATM 418, a bank branch device 420 (e.g., a recycler, a teller-controlled computer or device, etc.), or a SST 422, The server 402 may be in communication with a database 408. For example, the server 402 may store details about a transaction in the database 408. The server 402 includes a processor 404 and memory 406 for determining aspects of transaction scheduling.

The processor 404 may be used to receive a transaction task to be scheduled, such as from a user. The processor 404 may determine, such as by querying the database 408, scheduled tasks of the user (e.g., entries on a calendar of the user or determined from collected data including data of past user habits or locations). The processor 404 may provide a notification to the user (e.g., on the mobile device 410, the display device 416, the ATM 418, the bank branch device 420 (e.g., the recycler, the teller-controlled computer or device, etc.), or the SST 422), The notification may include a suggested time and day for performing the transaction task. The suggested time and day may be based on a scheduled location for at least one of the scheduled tasks. The suggested time and day for the transaction task may be stored in the memory 406 until confirmed by the user, and may be sent to the database 408 to be included with the scheduled tasks if confirmed by the user or automatically confirmed.

In an example, the processor 404 receives current location information for the user at a current time, such as from the location service 414 of the mobile device 410. The processor 404 may determine whether the current location information indicates an improvement to one or more parameters associated with the suggested time and day. The parameters may include a threshold distance to a completion location for the transaction task, a fee associated with performing the transaction task, a time to the completion location for the transaction task, a user preference, or the like. The processor 404 may send an indication to the mobile device 410 or to a currently used device (e.g., the display device 416, the ATM 418, the bank branch device 420 (e.g., the recycler, the teller-controlled computer or device, etc.), or the SST 422). The indication may be sent in response to the determination that the current location information indicates the improvement. If the determination indicates no improvement or insufficient improvement, the processor 404 may refrain from sending the indication.

In an example, the mobile device 410 may include a display 412 and a location service 414. Other communication devices (e.g., 416-422) may include location services or their locations may be known via other techniques (e.g., if they are static, the locations may be predetermined).

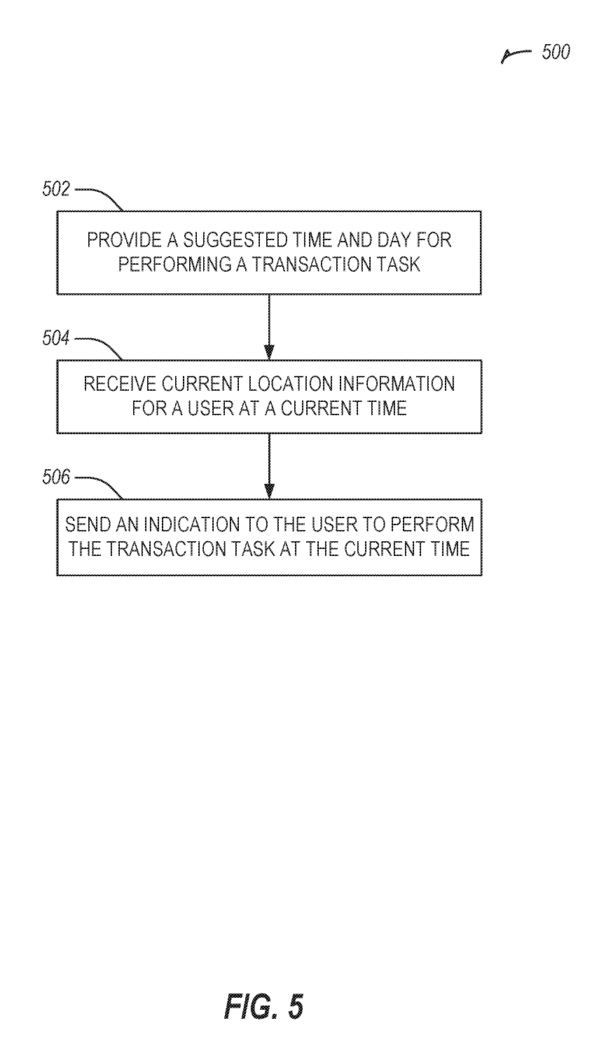

FIG. 5 illustrates generally a flowchart showing a technique 500 for transaction scheduling in accordance with some erribodiments. The technique 500 may include receiving a transaction task to be scheduled, such as from a user. Receiving the transaction task may include receiving the transaction task on at least one of a website, a mobile device, a self-service terminal (SST), or an automated teller machine (ATM). Scheduled tasks of the user may be determined, such as by evaluating calendar entries or determined from collected data including data of past user habits and locations.

The technique 500 includes an operation 502 to provide a suggested time and day for performing the transaction task. The suggested time and day may be based on a scheduled location for a previously scheduled task. Operation 502 may include adding the transaction task to a calendar at the suggested time and day. In an example, the transaction task may be received from a first device and the suggested time and day may be provided in a notification to a second device. Operation 502 may include identifying a person other than the user to complete the transaction task at the suggested time and day. The technique 500 may include sending a second indication to the user indicating that the task has been completed by a person other than the user. The technique 500 includes an operation 504 to receive current location information for a user at a current time.

The technique 500 includes an operation 506 to send an indication to the user to perform the transaction task at the current time. The indication may be sent in response to determining that the current location information indicates an improvement to one or more parameters associated with the suggested time and day. In an example, the one or more parameters may include a threshold distance to a completion location for the transaction task, a fee associated with performing the transaction task, a time to the completion location for the transaction task, a user preference, or the like. The indication may include a suggested route, including optional route paths, on a map user interface to complete the transaction task.

The technique 500 may include receiving a user modification to the suggested time and day. The suggested time and day may be rescheduled based on the user modification. The user modification may include a change in time, a change in day, a rejection of the suggested time and day, a change in location, or the like. The technique 500 may include determining the suggested time and day based on cash stock of an automated teller machine (ATM), a current wait time at a bank branch, traffic information, weather, construction, a user preference, or the like. The technique 500 may include automatically rescheduling the suggested time and day in response to determining a change in one of the scheduled tasks. In an example, the user modification may include a change to the transaction task. For example, the user modification may include changing details of the transaction task, such as an originally set task to withdraw $100 that is changed to withdraw $200. The change may be an automatic change (e.g., if the user waits two days to make the withdrawal, increase the amount by $100), a manual change (e.g., the user updates the calendar), or a change based on an input from another user (e.g., a family member semis a text to the user to request $100 for the family member, the transaction task may then be automatically adjusted to include withdrawing the $100 for the family member).

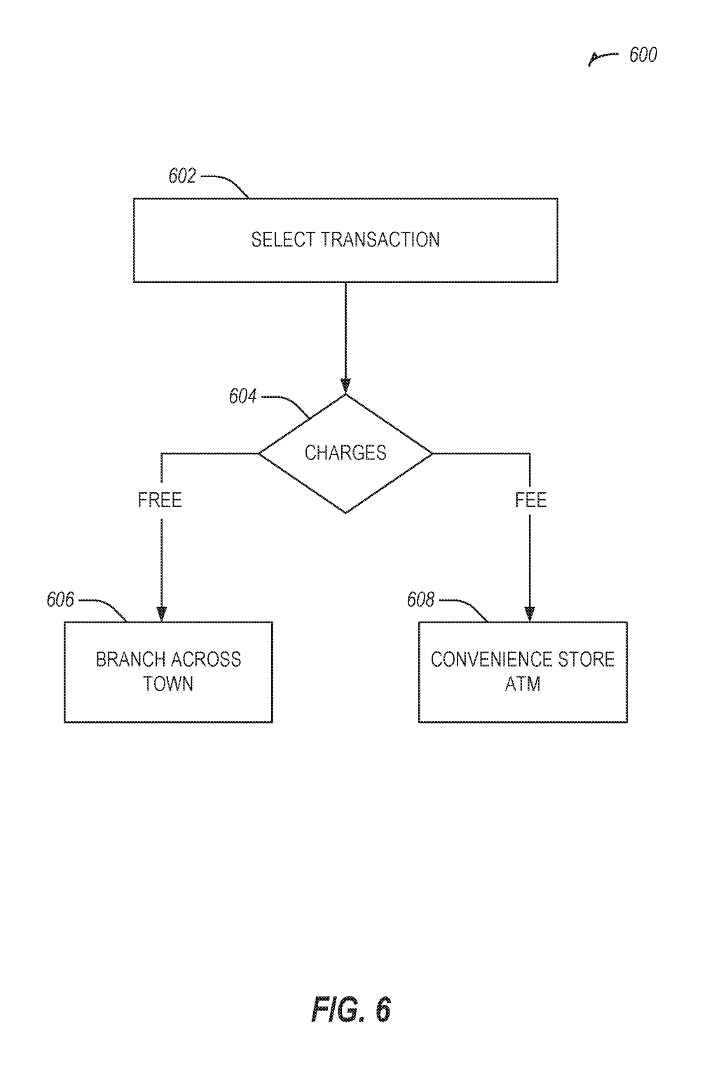

FIG. 6 illustrates generally a flowchart showing a technique 600 for providing options for fulfilling a transaction in accordance with some embodiments. For example, the technique 600 may include initiating a transaction on a first device, and providing options for completion of fhe transaction at other devices. For example, a transaction may be initiated on a browser of a computer or mobile device, and two options may be presented for completion at an ATM and a bank branch. The costs associated with the two options may be provided and a user may select one of the two options. The technique 600 includes an operation 602 to select transaction (or transactions).

The technique. 600 includes a decision operation 604 to determine whether options for completing the selected transaction based on whether the location will result in a fee charged for completing the selected transactions. The technique 600 includes an operation 606 to provide one or more free options for completing the selected transaction. The technique 600 includes an operation 608 to provide one or more options requiring a fee for completing the selected transaction. In an example, a fee option may be closer to a calendar event, closer to a user location, or closer to a known user-frequented location than a free option.

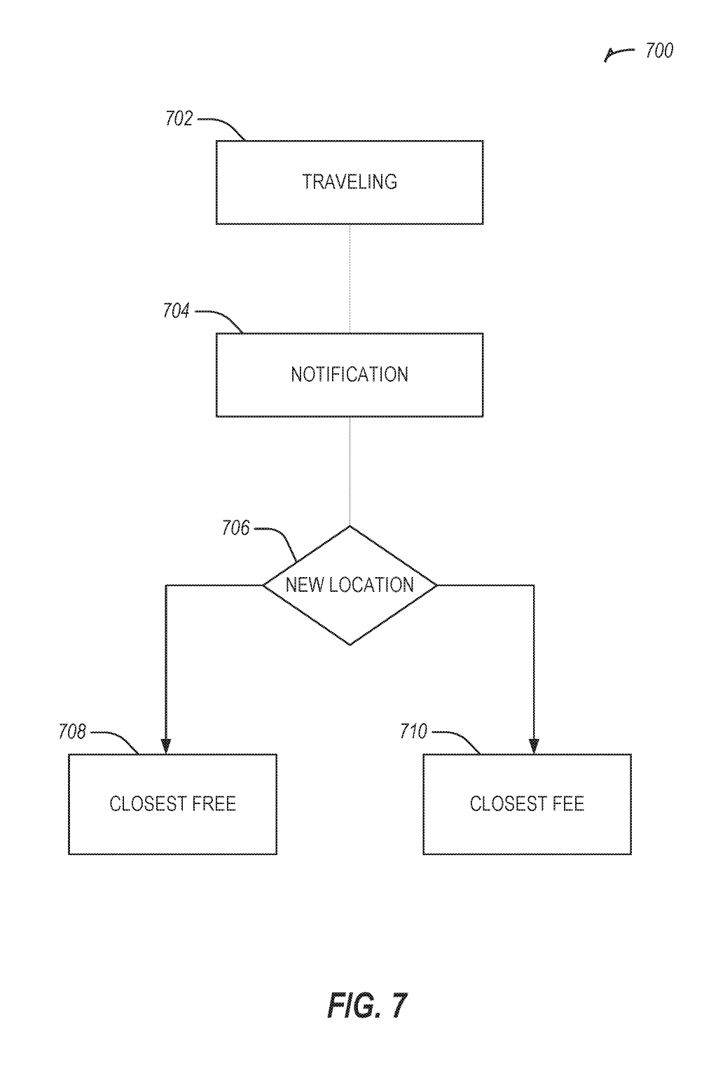

FIG. 7 illustrates generally a flowchart showing a technique 700 for updating transaction fulfillment options based on a change in availability in accordance with some embodiments. The change in availability may include a channel loss, such as a change in geographic area, where for example, no fee options may not exist or may be further away than a fee-based option. The technique 700 includes an operation 702 to determine that a user is moving, has pending travel scheduled, is determined to he moving soon, or is in transit. The technique 700 includes an operation 704 to send a notification that a previously selected option for completing a transaction is no longer available (e.g., due to the movement or transit).

The technique. 700 includes a decision operation 706 to determine at least one new location for completing the transaction. The technique 700 includes an operation 708 to provide a closest free location for completing the transaction. In an example, the closest free location may be closest to a future location of the user, such as along a route. The technique 700 includes an operation 710 to provide a closest fee-charging location for completing the transaction. In an example, the closest fee-charging location may be closest to a future location of the user, such as along a route. The free or fee-charging locations may be free or fee-charging for some specific transactions and not others.

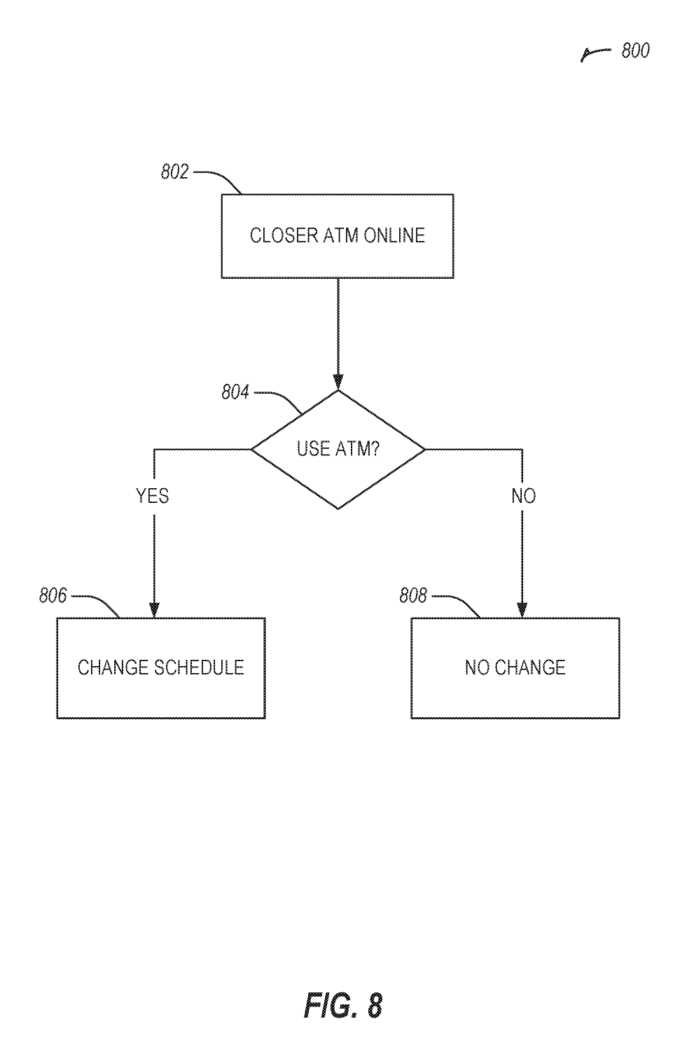

FIG. 8 illustrates generally a flowchart showing a technique 800 for providing updated transaction fulfillment options based on a location change in accordance with some embodiments. For example, updates may be provided based on a change in location of a user or an anticipated change of location of the user. As the location changes or is anticipated to change, new options may become available for the user to complete the transaction and notification may be made to change a current plan. The technique 800 includes an operation 802 to determine a closer ATM or transaction fulfillment location to a current location or future location of a user.

The technique 800 includes a decision operation 804 to receive a selection of whether to use the closer transaction fulfilment location. The technique 800 includes an operation 806 to change the scheduled location to the closer transaction fulfilment location, such as on a calendar, or reroute using a map app. Operation 806 may be performed in response to a selection in decision operation 804 to use the closer transaction fulfilment location. The technique 800 includes an operation 808 to maintain a previously selected location for fulfilling the transaction, such as in response to a selection in decision operation 804 to not use the closer transaction fulfilment location.

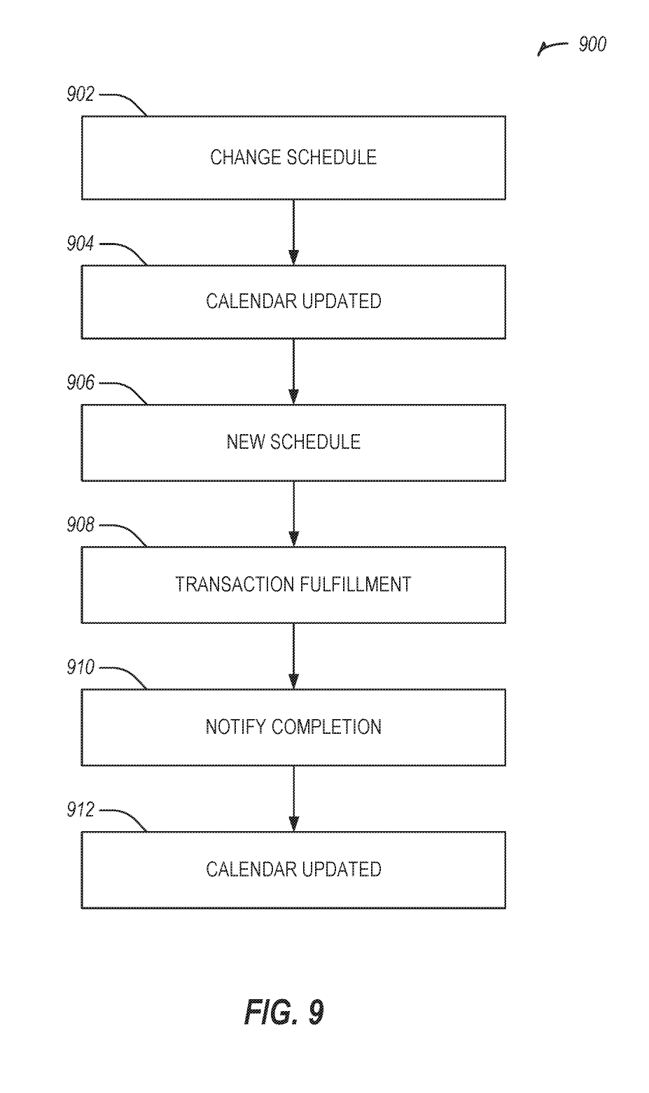

FIG. 9 illustrates generally a flowchart showing a technique 900 for calendar synchronization in accordance with some embodiments. The technique 900 includes an operation 902 to change a schedule, such as to update a scheduled transaction (e.g., move the transaction, delete the transaction, etc.). The technique 900 includes an operation 904 to update a calendar of a user based on the change in the schedule.

The technique 900 includes an operation 906 to provide details related to the new schedule, such as a route on a map app or a reminder or notification. The technique 900 includes an operation 908 to perform the transaction, such as at an ATM, bank branch, SST, etc. The technique 900 includes an operation 910 to notify the user or a system that the transaction is completed. The technique 900 includes an operation 912 to update the calendar with the completion information. For example, a user may change a calendar event (e.g., transaction) to another appropriate slot on the calendar. As the user completes the calendar event, the calendar event may be marked as completed.

FIG, 10 illustrates generally an example of a block diagram of a machine 1000 upon which any one or more of the techniques discussed herein may perform in accordance with some embodiments. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 1000 may include a hardware processor 1002 (e.g., a central processing unit (CPU), a graphics processing unit (GPU), a. hardware processor core, or any combination thereof), a main memory 1004 and a static memory 1006, some or all of which may communicate with each other via an interlink (e.g., bus) 1008. The machine 1000 may further include a display unit 1010, an alphanumeric input device 1012 (e.g,, a keyboard), and a user interface (UI) navigation device 1014 (e.g., a mouse). In an example, the display unit 1010, alphanumeric input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine readable medium 1022 that is non-transitory on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, and optical and magnetic media, Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old. Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1000, and includes digital or analog communications signals or other intangible medium to facilitate communication of such software.

### VARIOUS NOTES & EXAMPLES

Each of these non-limiting examples may stand on its own, or may be combined in various permutations or combinations with one or more of the other examples.

Example 1 is a method comprising: receiving, from a user, a transaction task to be scheduled; determining scheduled tasks of the user; providing a notification to the user including a suggested time and day for performing the transaction task based on a scheduled location for at least one of the scheduled tasks; receiving current location information for the user at a current time; determining whether the current location information indicates an improvement to one or more parameters associated with the suggested time and day; and in response to determining that the current location information indicates the improvement, sending an indication to the user to perform the transaction task at the current tune.

In Example 2, the subject matter of Example 1 optionally includes wherein the scheduled tasks are included on a calendar of a user.

In Example 3, the subject matter of Example 2 optionally includes wherein providing the notification includes adding the transaction task to the calendar at the suggested time and day.

In Example 4, the subject matter of any one or more of Examples 1-3 optionally include wherein the scheduled tasks are determined from collected data including data of past user habits and locations.

In Example 5, the subject matter of any one or more of Examples 1-4 optionally include receiving a user modification to the suggested time and day, and rescheduling the suggested time and day based on the user modification.

In Example 6, the subject matter of Example 5 optionally includes wherein the user modification includes at least one of a change in time, a change in day, a rejection of the suggested time and day, or a change in location.

In Example 7, the subject matter of any one or more of Examples 1-6 optionally include wherein receiving the transaction task includes receiving the transaction task on at least one of a website, a mobile device, a self-service terminal (SST), or an automated teller machine (ATM).

In Example 8, the subject matter of any one or more of Examples 1-7 optionally include wherein the transaction task is received from a first device and the notification is provided to a second device.

In Example 9, the subject matter of any one or more of Examples 1-8 optionally include determining the suggested time and day based on at least one of cash stock of an automated teller machine (ATM), a current wait time at a bank branch, traffic information, weather, construction, or a user preference.

In Example 10, the subject matter of any one or more of Examples 1-9 optionally include automatically rescheduling the suggested time and day in response to determining a change in one of the scheduled tasks.

In Example 11, the subject matter of any one or more of Examples 1-10 optionally include wherein sending the indication includes providing a suggested route on a map user interface to complete the transaction task.

In Example 12, the subject matter of any one or more of Examples 1-11 optionally include wherein the one or more parameters include at least one of a threshold distance to a completion location for the transaction task, a fee associated with performing the transaction task, a time to the completion location for the transaction task, or a user preference.

In Example 13, the subject matter of any one or more of Examples 1-12 optionally include wherein the notification includes an identification of a person other than the user to complete the transaction task.

In Example 14, the subject matter of any one or more of Examples 1-13 optionally include sending a second indication to the user indicating that the task has been completed by a person other than the user.

Example 15 is a method comprising: providing a notification to a user including a suggested time and day for performing a transaction task based on a scheduled location for a previously scheduled task; receiving current location information for the user at a current time; and in response to determining that the current location information indicates an improvement to one or more parameters associated with the suggested time and day, sending an indication to the user to perform the transaction task at the current time.

In Example 16, the subject matter of Example 15 optionally includes receiving a user modification to the suggested time and day, and rescheduling the suggested time and day based on the user modification.

In Example 17, the subject matter of Example 16 optionally includes wherein the user modification includes at least one of a change in time, a change in day, a rejection of the suggested time and day, or a change in location.

Example 18 is a system comprising: a processor to: receive, from a user, a transaction task to be scheduled; determine, by querying a database, scheduled tasks of the user; provide a notification to the user including a suggested time. and day for performing the transaction task based on a scheduled location for at least one of the scheduled tasks; receive, from a location service of a mobile device, current location information for the user at a current time; determine whether the current location information indicates an improvement to one or more parameters associated with the suggested time and day; and in response to the determination that the current location information indicates the improvement, send an indication to the mobile device to perform the transaction task at the current time.

In Example 19, the subject matter of Example 18 optionally includes wherein the one or more parameters include at least one of a threshold distance to a completion location for the transaction task, a fee associated with performing the transaction task, a time to the completion location for the transaction task, or a user preference.

In Example 20, the subject matter of any one or more of Examples 18-19 optionally include wherein the scheduled tasks are determined from collected data including data of past user habits and locations.

Example 21 is at least one machine-readable medium including instructions, which when performed by a machine, cause the machine to: receive, from a user, a transaction task to be scheduled; determine scheduled tasks of the user; provide a notification to the user including a suggested time and day for performing the transaction task based on a scheduled location for at least one of the scheduled tasks; receive current location information for the user at a current time; determine whether the current location information indicates an improvement to one or more parameters associated with the suggested time and day; and in response to the determination that the current location information indicates the improvement, send an indication to the user to perform the transaction task at the current time.

In Example 22, the subject matter of Example 21 optionally includes instructions that cause the machine to receive a user modification to the suggested time and day, and rescheduling the suggested time and day based on the user modification.

In Example 23, the subject matter of Example 22 optionally includes wherein the user modification includes at least one of a change in time, a change in day, a rejection of the suggested time and day, or a change in location.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving, from a user, a transaction task to be scheduled;
determining scheduled tasks of the user;
providing a notification to the user including a suggested time and day for performing the transaction task based on a scheduled location for at least one of the scheduled tasks;
receiving current location information for the user at a current time;
determining whether the current location information indicates an improvement to one or more parameters associated with the suggested time and day; and
in response to determining that the current location information indicates the improvement, sending an indication to the user to perform the transaction task at the current time.

2. The method of claim 1, wherein the scheduled tasks are included on a calendar of a user.

3. The method of claim 2, wherein providing the notification includes adding the transaction task to the calendar at the suggested time and day.

4. The method of claim 1, wherein the scheduled tasks are determined from collected data including data of past user habits and locations.

5. The method of claim 1, further comprising receiving a user modification to the suggested time and day, and rescheduling the suggested time and day based on the user modification.

6. The method of claim 5, wherein the user modification includes at least one of a change in time, a change in day, a rejection of the suggested time and day, or a change in location.

7. The method of claim 1, wherein receiving the transaction task includes receiving the transaction task on at least one of a website, a mobile device, a self-service terminal (SST), or an automated teller machine (ATM).

8. The method of claim 1, wherein the transaction task is received from a first device and the notification is provided to a second device.

9. The method of claim 1, further comprising determining the suggested time and day based on at least one of cash stock of an automated teller machine (ATM), a current wait time at a bank branch, traffic information, weather, construction, or a user preference.

10. The method of claim 1, further comprising automatically rescheduling the suggested time and day in response to determining a change in one of the scheduled tasks.

11. The method of claim 1, wherein sending the indication includes providing a suggested route on a map user interface to complete the transaction task.

12. The method of claim 1, wherein the one or more parameters include at least one of a threshold distance to a completion location for the transaction task, a fee associated with performing the transaction task, a time to the completion location for the transaction task, or a user preference.

13. The method of claim 1, wherein the notification includes an identification of a person other than the user to complete the transaction task.

14. The method of claim 1, further comprising sending a second indication to the user indicating that the task has been completed by a person other than the user.

15. A method comprising:
providing a notification to a user including a suggested time and day for performing a transaction task based on a scheduled location for a previously scheduled task;
receiving current location information for the user at a current time; and
in response to determining that the current location information indicates an improvement to one or more parameters associated with the suggested time and day, sending an indication to the user to perform the transaction task at the current time.

16. The method of claim 15, further comprising receiving a user modification to the suggested time and day, and rescheduling the suggested time and day based on the user modification.

17. The method of claim 16, wherein the user modification includes at least one of a change in time, a change in day, a rejection of the suggested time and day, or a change in location.

18. A system comprising:
a processor to:
receive, from a user, a transaction task to be scheduled;
determine, by querying a database, scheduled tasks of the user;
provide a notification to the user including a suggested time and day for performing the transaction task based on a scheduled location for at least one of the scheduled tasks;
receive, from a location service of a mobile device, current location information for the user at a current time;
determine whether the current location information indicates an improvement to one or more parameters associated with the suggested time and day; and
in response to the determination that the current location information indicates the improvement, send an indication to the mobile device to perform the transaction task at the current time.

19. The system of claim 18, wherein the one or more parameters include at least one of a threshold distance to a completion location for the transaction task, a fee associated with performing the transaction task, a time to the completion location for the transaction task, or a user preference.

20. The system of claim 18, wherein the scheduled tasks are determined from collected data including data of past user habits and locations.
